(19) United States
(12) Patent Application Publication
(10) Pub. No.: US 2018/0328744 A1
(43) Pub. Date: Nov. 15, 2018

(54) TRAVELLING ROAD INFORMATION GENERATION SYSTEM OF VEHICLE AND ON-BOARD APPARATUS BASED ON CORRECTION AMOUNT

(71) Applicant: DENSO CORPORATION, Kariya-city, Aichi-pref. (JP)

(72) Inventors: Teppei MIYAKE, Kariya-city, Aichi-pref. (JP); Minoru OKADA, Kariya-city, Aichi-pref. (JP)

(21) Appl. No.: 15/775,799

(22) PCT Filed: Nov. 11, 2016
(86) PCT No.: PCT/JP2016/083555

§ 371 Date: May 11, 2018

(30) Foreign Application Priority Data
Nov. 13, 2015 (JP) 2015-223181

(51) Int. Cl. G01C 21/32; G01C 21/36; G06F 17/30; B60R 11/04

(52) U.S. Cl. CPC G01C 21/32; B60R 11/04; G06F 17/30241; G01C 21/367

(57) ABSTRACT

The travelling road information generation system is provided with a map data acquiring unit, a locus data acquiring unit, a correction amount calculation unit, and a travelling road information generation unit.

The map data acquiring unit acquires map data including a travelling road on which the vehicle is capable of travelling, and the locus data acquiring unit acquires locus data indicating a running locus when the vehicle actually travels on the travelling road.

The correction amount calculation unit calculates, based on the locus data, a correction amount necessary for generating travelling road information from the map data, the travelling road information being suitable for travelling of the vehicle, and the travelling road information generation unit corrects the travelling road acquired from the map data using the correction amount to generate the travelling road information.

### CROSS-REFERENCE TO RELATED APPLICATION

This application is based on and claims the benefit of priority from earlier PCT Application No. PCT/JP2016/083555, filed on Nov. 11, 2016, which claims priority from Japanese Patent Application No. 2015-223181, filed on Nov. 13, 2015, the description of which is incorporated herein by reference.

### BACKGROUND OF THE INVENTION

### Technical Field

The present disclosure relates to a travelling road information generation system of a vehicle, and an on-vehicle apparatus suitable for generating traveling road information of the vehicle used for travelling guidance, automatic driving or the like of the vehicle.

### Background Art

In a navigation apparatus mounted on a vehicle, it is common that own map data is generated based on a running state of the vehicle other than map data stored in advance, and these data are combined, thereby generating guide map data used for travelling guidance.

As an example of the above-mentioned apparatus, Japanese Patent Application Laid-Open Publication Number 2014-126647 proposes a configuration in which server-updated map data is acquired from the server in order to correct original map data, and map data having no overlapped region between the server-updated map data and the own map data is obtained as new own map data. According to this apparatus, intermediate map data is produced by updating the original map data with the server-updated map data, and the intermediate map data and the new own map data are combined, whereby a guide map data is generated for the travelling guidance.

### CITATION LIST

### Patent Literature

[PTL 1] JP-A-2014-126647

According to the above-mentioned apparatus, the map data having no overlapped region between the own map data and the server-updated map data is extracted and the extracted data is combined with the intermediate map data. Hence, guide map data corresponding to actually existing road can be generated.

Conventional map data is effective when being used for route guidance such as in a car-navigation system or the like. However, the travelling road where the vehicle actually travels may change depending on conditions of a running environment of the vehicle such as time period, season, meteorological conditions, regions or the like. For this reason, even when the above-described guide map data is generated, appropriate traveling guide is unlikely to be achieved.

Further, in the case where the travelling road information is generated by using the guide map data produced in the above-described conventional technique to perform automatic driving of the vehicle, an optimized travelling road may not be provided from the travelling road information. In this case, when the vehicle runs, the state of the travelling road has to be detected by using a camera and sensors and the running route of the vehicle is required to be corrected. However, if errors in the travelling road information become large because of a change in environmental factors, a large amount of correction for the running route is frequently performed. As a result, passengers in the vehicle feel discomfort.

### SUMMARY

According to the present disclosure, a technique is provided which is capable of appropriately generating the travelling road information based on environmental changes when the travelling road information is used for a travel guidance or an automatic driving operation or the like.

### Solution to Problem

The travelling road information generation system according to the present disclosure is provided with a map data acquiring unit, a locus data acquiring unit, a correction amount calculation unit, and a travelling road information generation unit.

The map data acquiring unit acquires map data including a travelling road on which the vehicle is capable of travelling, and the locus data acquiring unit acquires locus data indicating a running locus when the vehicle actually travels on the travelling road.

The correction amount calculation unit calculates, based on the locus data, a correction amount necessary for generating travelling road information from the map data, the travelling road information being suitable for travelling of the vehicle, and the travelling road information generation unit corrects the travelling road acquired from the map data using the correction amount to generate the travelling road information.

Thus, according to the travelling road information generation system of the present disclosure, by using the correction amount generated by using the locus data indicating the running locus of the vehicle, the travelling road acquired from the map data is corrected to generate the travelling road information.

Therefore, according to the present disclosure, even when the travelling road acquired from the map data is deviated from the optimized travelling road corresponding to the running environment because of a change in the running environment such as time period, season, meteorological conditions, region or the like, the travelling road can be corrected based on the deviation. Hence, optimized travelling road information can be provided.

Therefore, by using the travelling road information, even in a case where the vehicle is guided by a navigation apparatus or the like, or the vehicle is automatically driven, travel guidance or vehicle control can be appropriately performed.

Further, according to the present disclosure, the map data is not corrected using the correction amount generated from the locus data, but the travelling road acquired from the map data is corrected to generate the travelling road information. Hence, the map data can be used in an initial state.

In other words, since the running environment varies depends on the season, meteorological conditions or the like, when trying to update the map data, depending on the variation, frequent updates are required, which causes control to be complicated.

However, according to the present disclosure, the map data itself is not corrected, so that a processing load caused by updating the map can be reduced. Moreover, since erroneous update of the map data can be avoided, reliability of the travelling information can be prevented from being lowered.

The travelling road information generation system according to the present disclosure may be configured of an on-vehicle apparatus provided with all functions. Moreover, the travelling road information generation system according to the present disclosure may be configured of on-road equipment or a server that generates correction amount data and provides them to a plurality of vehicles, and an on-vehicle apparatus that generates the travelling road information based on the correction amount provided by the on-road equipment or the server.

The on-vehicle apparatus may be configured of the correction amount acquiring unit that acquires the correction amount from the on-road equipment or the server which are apparatus providing the correction amount, in addition to the map data acquiring unit and the travelling road information generation unit.

### BRIEF DESCRIPTION OF THE DRAWINGS

In the accompanying drawings:

FIG. 1 is a block diagram showing an overall configuration of the travelling road information generation system of the embodiment;

FIG. 2 is an explanatory table showing a configuration of correction amount data stored in a correction amount database (DB) in a server computer;

FIG. 3 is a flowchart showing a correction amount DB updating process which is executed by an execution unit of the server;

FIG. 4 is a flowchart showing a control process executed by the control unit of the server and the on-vehicle apparatus for transmitting/receiving the correction amount;

FIG. 5 is an explanatory diagram showing a travelling road obtained from map data, and a running locus obtained from the vehicle;

FIG. 6 is an explanatory diagram showing an operation for determining a distance between the travelling road on the map and the running locus;

FIG. 7 is an explanatory diagram showing an operation for determining reliability of the running locus acquired from the vehicle;

FIG. 8 is an explanatory diagram showing an operation for calculating correction amount of the travelling road on the map in accordance with the running locus;

FIG. 9 is an explanatory diagram showing an operation for generating the travelling road information by using the correction amount;

FIG. 10 is an explanatory diagram showing an example of generating the traveling road information obtained eventually;

FIG. 11 is an explanatory diagram showing an example of the traveling road information which varies depending on the running environment; and

FIG. 12 is a block diagram showing an on-vehicle apparatus according to a modification example.

### DETAILED DESCRIPTION OF THE PREFERRED EMBODIMENTS

Hereinafter, with reference to the drawings, embodiments of the present disclosure will be described.

Note that the present disclosure should not be interpreted as being limited to the following embodiments. Also, a part of configuration in the following embodiment can be omitted as long as the problem is solved, and such a configuration is also regarded as an embodiment of the present disclosure. Moreover, various possible modifications can be made as embodiments of the present disclosure without departing from the spirit of the present disclosure which is identified only by terms described in the claims. Further, reference signs used in the following embodiments are appropriately used in the claims, but this is used to easily understand the present disclosure and does not limit the technical scope of the present disclosure.

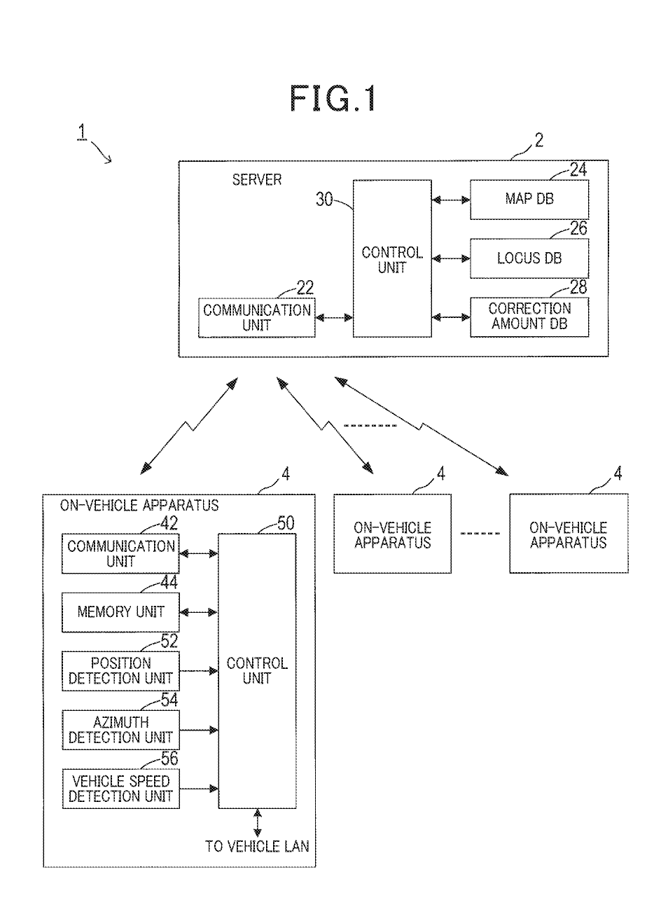

As shown in FIG. 1, a travelling road information generation system 1 of the present embodiment is provided with a server 2 provided on the communication network, a plurality of on-vehicle apparatuses 4 being mounted on respective vehicles.

Note that the communication network is provided to allow the server 2 and the plurality of on-vehicle apparatuses 4 to perform wireless communication therebetween. For example, a mobile communication network or the internet can be employed.

The server 2 is provided with a communication unit 22, a map DB24, a locus DB 26, a correction amount DB 28 and control unit 30. Note that DB is used to refer to a database. The communication unit 22 performs a wireless communication between the plurality of on-vehicle apparatuses 4 via the communication network.

The map DB 24 is a memory unit in which map data is stored in advance including travelling roads on which the vehicle is capable of travelling. For example, the map DB 24 is configured of an optical disk such as a CD (compact disk), DVD (digital versatile disk) and their reader device, or readable and writeable recoding media such as a hard disk, a solid state disk or the like.

The locus DB 26 is a memory unit that stores received locus data transmitted from the on-vehicle apparatuses 4, and the correction amount DB 28 is a memory unit that stores correction amount data corresponding to the map data stored in the map DB 24.

The locus DB 26 and the correction amount DB 28 are required to newly register or update locus data or correction amount data. Hence, the locus DB 26 and the correction amount DB 28 are configured of a readable/writeable storage media such as a hard disk, a solid state disk and a non-volatile memory device.

The control unit 30 is configured of a computer, and executes a correction amount DB updating process and a correction amount transmission process in accordance with the program. The correction amount DB updating process uses locus data representing the actual running locus of the vehicle stored in the locus DB 26, calculates the correction amount for correcting the travelling road obtained from the map data stored in the map DB 24, and stores the calculated correction amount into the correction amount DB 28 as the correction amount data.

In the correction amount DB updating process, the process obtains a difference between the travelling road and the running locus of the vehicle (i.e., positional deviation) for each node N1, N2, N3 and the like on the travelling road acquired from the map data, thereby setting the correction amount to correct the position of each node.

In the locus DB 26, the locus data obtained from the vehicle is stored being associated with the running environment of the vehicle, in which the correction amount is provided for each of a plurality of running environments A, B, C and the like categorized from the running environment.

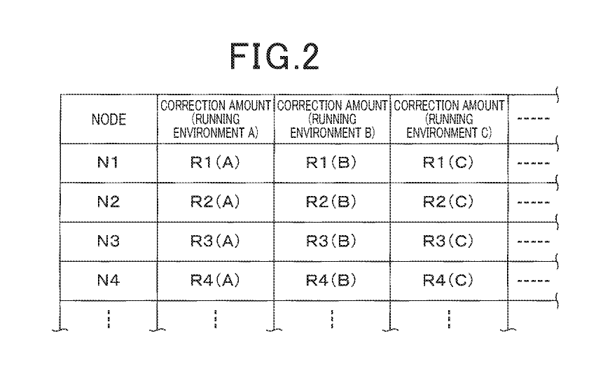

In the correction amount DB 28, as shown in FIG. 2, correction amounts R1 (A), R2 (A), R3 (A). . . , R1 (B), R2 (B), R3(B) and the like corresponding to the respective running environments A, B, C and the like are stored for each of the nodes N1, N2, N3 and the like on the travelling road obtained from the map data.

Note that the running environment A, B, C and the like have been appropriately categorized based on conditions assuming that the amount of deviation of the travelling road obtained from the map data will be changed. These conditions include time periods such as late at night and in the daytime, seasons such as winter, meteorological conditions such as seasonal heavy rain and other weather and temperature, and regions such as heavy snowfall regions, mountainous regions and the like.

The correction amount stored in the correction amount DB 28 may be set for the entire travelling road obtained from the map data or may be set for a specific travelling road set in advance. The specific travelling road may be set for places where the vehicle is unable to travel in accordance with the map because of a change in the environment of the travelling road, such as intersections, sharp curves or the like.

Next, the correction amount transmission process transmits the correction amount data stored in the correction amount DB 28 to the on-vehicle 4 via the communication network. According to the correction amount transmission process, the process reads, in accordance with a requirement of the on-vehicle apparatus 4, the map data corresponding to the position and the running environment of the vehicle provided with the on-vehicle apparatus 4 and transmits the read map data to the on-vehicle apparatus 4.

On the other hand, the on-vehicle apparatus 4 is provided with a communication unit 42, memory unit 44, a control unit 50, a position detection unit 52, an azimuth detection unit 54 and vehicle speed detection unit 56. The on-vehicle apparatus 4 is provided in each of a plurality of the vehicles. However, configurations of the on-vehicle apparatuses 4 between the vehicles are the same.

The communication unit 42 is used for performing wireless communication with the server 2 using radio waves. The memory unit 44 stores various data. The memory unit 44 stores map data obtained from the navigation apparatus or the like mounted on the vehicle, locus data indicating the locus of the own vehicle and correction amount data obtained from the server 2. Hence, a rewriteable non-volatile memory is used for the memory unit 44.

The position detection unit 52 is used for detection of an absolute position of the own vehicle provided with the on-vehicle apparatus 4. According to the present embodiment, a receiving apparatus such as a GPS receiver or the like is used to receive radio waves transmitted by a satellite of a satellite positioning system to detect the latitude, the longitude and the altitude of the own vehicle and the current time. Note that GPS is an abbreviation of Global Positioning System.

The azimuth detection unit 54 detects a running direction (e.g., absolute azimuth) of the own vehicle. According to the present embodiment, a gyroscope is used to output a detection signal based on the angular velocity of a rotary motion applied to the vehicle. Instead of using the gyroscope, or together with the gyroscope, for example, a geomagnetic sensor may be used to detect the absolute azimuth of the own vehicle based on the geomagnetism.

The vehicle speed detection unit 56 uses a vehicle speed sensor mounted on the vehicle to detect the travelling speed of the own vehicle. The control unit 50 is configured of a computer and executes various processes in accordance with the program.

Specifically, the control unit 50 performs a running locus measurement process when the own vehicle is travelling in which the position detection unit 52, the azimuth detection unit 54, and the vehicle speed detection unit 56 are used to periodically measure the travelling road information indicating the running locus, and the travelling road information and together with the measurement time are stored into the memory unit 44.

The travelling road information includes a vehicle position, a travelling direction, and a vehicle speed, which are stored into the memory unit 44 together with the time information indicating the measurement time. The measurement time is one piece of information indicating a running environment of the vehicle. However, in addition to the measurement time, a tire slip ratio, operational state of the wiper, and the outside temperature may be stored into the memory unit 44 together with the above-described travelling road information as the vehicle information representing the running environment of the vehicle.

In this case, the tire slip ratio can be calculated from the rotational angle of the wheel which is detectable by sensors mounted on the vehicle, and the vehicle speed. The slip ratio can be used as road information indicating a state of the road surface. The operational state of the wiper can be used as meteorological information indicating weather condition (i.e., rainfall).

The control unit 50 also performs a locus data transmission process in which travelling road information for every measurement time stored in the memory unit 44 is transmitted to the server 2 at a predetermined timing together with identification information of the own vehicle as locus data indicating the running locus.

Note that the timing at which the locus data is transmitted to the server 2 may occur every predetermined period, while the vehicle is running. Moreover, the transmission timing may be a timing at which the vehicle is stopped or parked, or may be a timing at which the driver inputs a transmission command as an external operation.

The control unit 50 includes communication function performing data communication with other on-vehicle apparatuses via a vehicle LAN such as CAN, for example. The control unit 50 performs, when receiving a request signal for the travelling road information from other on-vehicle apparatus via the on-vehicle LAN, a travelling road information generation process, in which the travelling road information for the scheduled travelling route of the vehicle is generated and outputs the generated travelling road information via the vehicle LAN.

Other on-vehicle apparatus which transmits the request signal of the travelling road information to the on-vehicle apparatus 4 includes a navigation apparatus that performs travelling guidance to the driver and a travelling control apparatus that performs automatic driving of the vehicle.

According to the present embodiment, each of these on-vehicle apparatuses includes recording media which store map data similar to the map data stored in the map DB 24 of the sever 2. The control unit 50 acquires the map data from the on-vehicle apparatus and generates the travelling road information to be used as the travelling route of the vehicle.

Next, the correction amount DB updating process and correction amount transmission process executed by the control unit 30 of the server 2, and the travelling road information generation process will be described. The correction amount DB updating process is activated when the communication unit 22 receives the locus data transmitted from the on-vehicle apparatus 4.

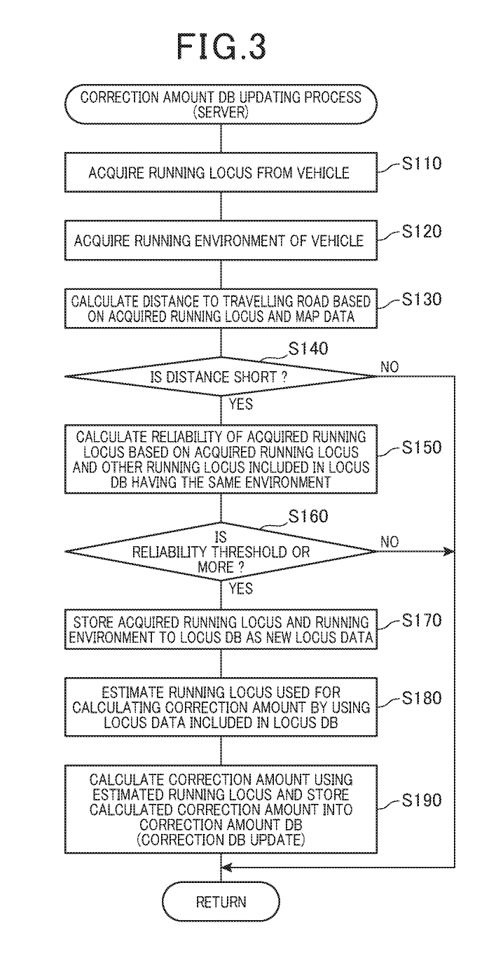

As shown in FIG. 3, when the correction amount DB updating process is activated, the process acquires the locus data received by the communication unit 22 at S110, and proceeds to S120. At S120, the process utilizes information (e.g., measurement time, vehicle position) obtained from the locus data acquired at S110, and also from various sensors (e.g., temperature sensor, solar sensor) disposed around the travelling road, and an external server, and acquires the above-described various running environments.

Next, at S130, as shown in FIG. 5, the process acquires the travelling road on the map corresponding to the locus data acquired at S110 from the map data stored in the map DB 24, acquires the running locus from the locus data, and calculates the distance between the travelling road and the running locus.

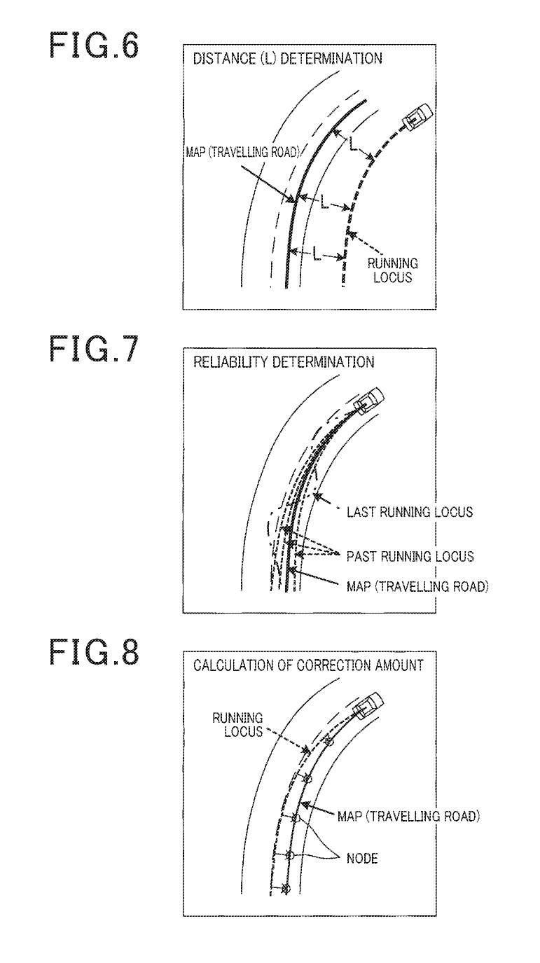

Specifically, as exemplified in FIG. 6, the process identifies corresponding positions between the travelling road and the running locus and calculates each distance L between respective corresponding positions, and calculates the maximum or the average value in the distance values L to be an amount of deviation between the travelling road and the running locus.

Next, at S140, the process determines whether the travelling road on the map and the running locus are close to each other, by determining whether the distance calculated at S130 is a predetermined threshold or less. Then, the process proceeds to S150 when determining that the distance is less than or equal to the threshold and the travelling road on the map and the running locus are close to each other, and otherwise the process determines that the acquired locus data is abnormal because the locus data acquired at present time is too far apart from the travelling road, and terminates the correction amount DB updating process.

At S150, the process extracts locus data corresponding to the running locus acquired from the locus data acquired at S110 (i.e., travelling road) and having the same running environment as that acquired at S120.

At S150, the process compares the running locus acquired from the extracted locus data and the running locus acquired from the locus data acquired at S110, thereby calculating reliability of the locus data which is acquired at the present time.

The reliability is calculated for locus data of which the number of samples for the travelling road information constituting the locus data acquired at the present time is larger than or equal to the predetermined threshold, and a minimum reliability is set for locus data having a smaller number of samples.

Also, for the locus data having the number of samples exceeding the threshold hold, the process calculates a dispersion value that indicates to what extent the running locus acquired from the locus data is dispersed with respect to the running locus acquired from the locus data extracted from the locus DB 26, and determines the calculated dispersion value to be the reliability.

Then, at subsequent step S160, the process determines whether the calculated reliability at S150 is the predetermined threshold or more, thereby determining whether the reliability of the locus data acquired at S110 is statistically high.

In other words, according to the present embodiment, as exemplified in FIG. 7, the process compares the most recent running locus acquired from the locus data acquired at the present time and past running locus stored in the locus DB 26, thereby determining whether the locus data acquired at the present time has statistically high reliability.

At S160, when the process determines that the reliability calculated at S150 is larger than or equal to the threshold, the process proceeds to S170 since the locus data acquired at S110 has high reliability, otherwise it terminates the correction amount DB updating process. Note that the locus data acquired at S110 is discarded when the process terminates the correction amount DB updating process.

At S170, the process stores the locus data acquired at S110 into the locus DB 26 as new locus data and proceeds to S180. Note that when storing the locus data into the locus DB 26, various running environment information is added to the locus data. Moreover, when storing the locus data into the locus DB 26, if the number of locus data having the same running environment stored in the locus DB 26 reaches the upper limit, the process removes locus data generated by the on-vehicle apparatus 4 at the oldest time and stores new locus data.

Next at S180, the process estimates the running environment the running locus where the vehicle actually runs by using data from the locus DB26, that is, stored locus data stored at S170 and past locus data corresponding to the stored locus data, having the same running environment, and proceeds to S190.

At S190, the process acquires, form the map DB 24, the map data of which the region corresponds to the estimated running locus estimated at S180. At S190, the process calculates a difference between the travelling road on a map obtained from the map data acquired from the map DB 24 and the running locus estimated at S180, to be a correction amount of the travelling road, and stores the calculated difference into the correction amount DB 28, and terminate the correction amount DB updating process.

As shown in FIG. 8, the process calculates at S190, how much the running locus is deviated in a direction perpendicular to the travelling road to detect the correction amount (i.e., difference) for respective nodes on the traveling road obtained from the map data.

Specifically, according to the present embodiment, for example, the process calculates distance and direction to a point on the running locus located in a direction perpendicular to the travelling road from each node, to be a horizontal deviation (i.e., difference) for each node. Then, the process determines the correction amount from the horizontal deviation.

Note that the correction amount may be set by calculating a difference between a coordinate position on a map coordinate (e.g., three-dimensional coordinate X,Y,Z) of each node on the travelling road and a coordinate position after the node has moved along the running locus (e.g., ΔX, ΔY, ΔZ).

At S190, when the correction amount is stored into the correction amount DB 28, if the correction amount to the travelling road corresponding to the correction amount calculated at the present time is already stored in the correction amount DB 28, the process updates the correction amount data by overwriting the correction amount calculated at the present rime.

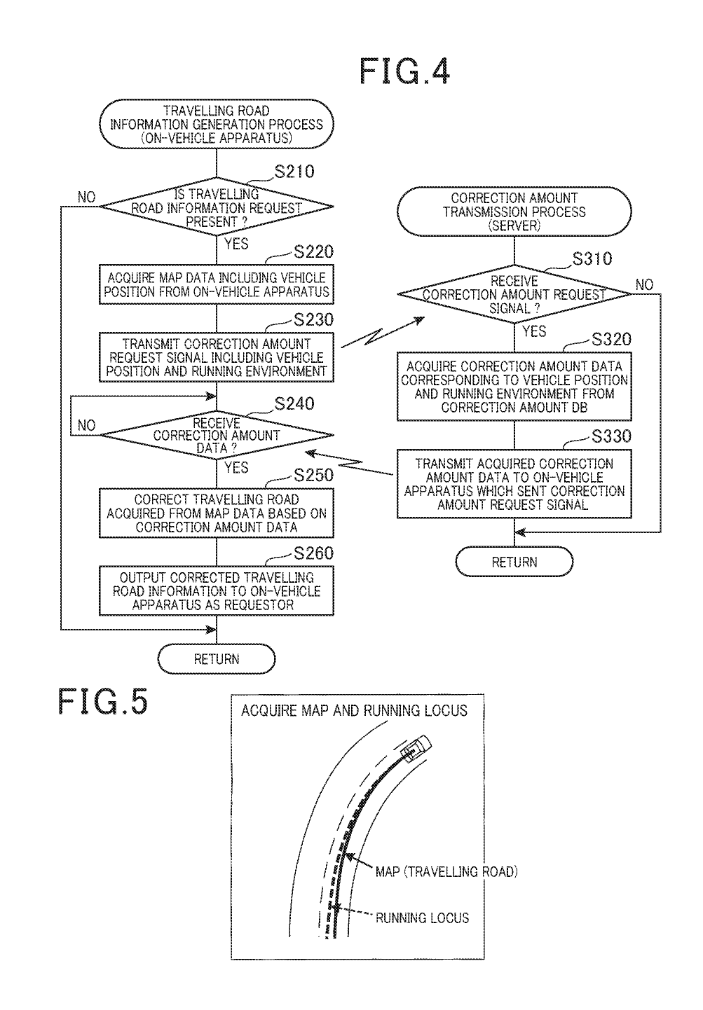

Next, the control unit 50 of the on-vehicle apparatus 4 repeatedly executes the travelling road information generation process shown in FIG. 4 as one of the main routines. In this travelling road information generation process, the process determines whether another on-vehicle apparatus has requested travelling road information via the vehicle LAN. The process terminates the travelling road information generation process when determining that no travelling road information request has accepted. The process proceeds to S220 when determining that another on-vehicle apparatus has requested travelling road information.

At S220, the process acquires a map data of a region where the current vehicle position is included and travelling road information requested by the on-vehicle apparatus has to be generated therefrom. Subsequently, at S230, the process transmits a correction amount request signal to the server 2 via the communication unit 42. Note that the position information indicating the current vehicle position, information indicating a running environment obtained in the vehicle-side, and information indicating travelling road as a correction object are added to the correction amount request signal to be transmitted to the server 2.

The control unit 30 of the server 2 repeatedly executes a correction amount transmission process shown in FIG. 4 as one of the main routines. In the correction amount transmission process, at S310, the process determines whether the communication unit 22 has received the correction amount request signal transmitted by the on-vehicle apparatus 4. When determining that the correction amount request signal is received at S310, the process proceeds to S320, and terminates the correction amount transmission process when the correction amount request signal is not received.

At S320, the process acquires, from the correction amount DB 28, correction amount data which is necessary for generating the travelling road information in the on-vehicle apparatus 4 side. When acquiring the correction amount data from the correction amount DB 28 at S320, the process uses information such as the vehicle position and running environment included in the correction amount request signal, and information indicating the travelling road, and weather information, which are not included in the correction amount request signal. As a result, at S320, the correction amount data including such information is acquired from the correction amount DB 28.

At S330, the process transmits the correction amount data acquired at S320 to the on-vehicle apparatus 4 which has transmitted the correction amount request signal, and terminates the correction amount transmission process. Next, the control unit 50 of the on-vehicle apparatus 4 proceeds to S240 when completing the transmission of the correction amount request signal to the server 2 at S230, and waits until the communication unit 42 receives the correction amount data transmitted from the server 2.

When determining that the correction amount data is received at S240, the process proceeds to S250 and corrects the travelling road on the map data acquired from the on-vehicle apparatus based on the correction amount data acquired from the server 2 to generate the travelling road information.

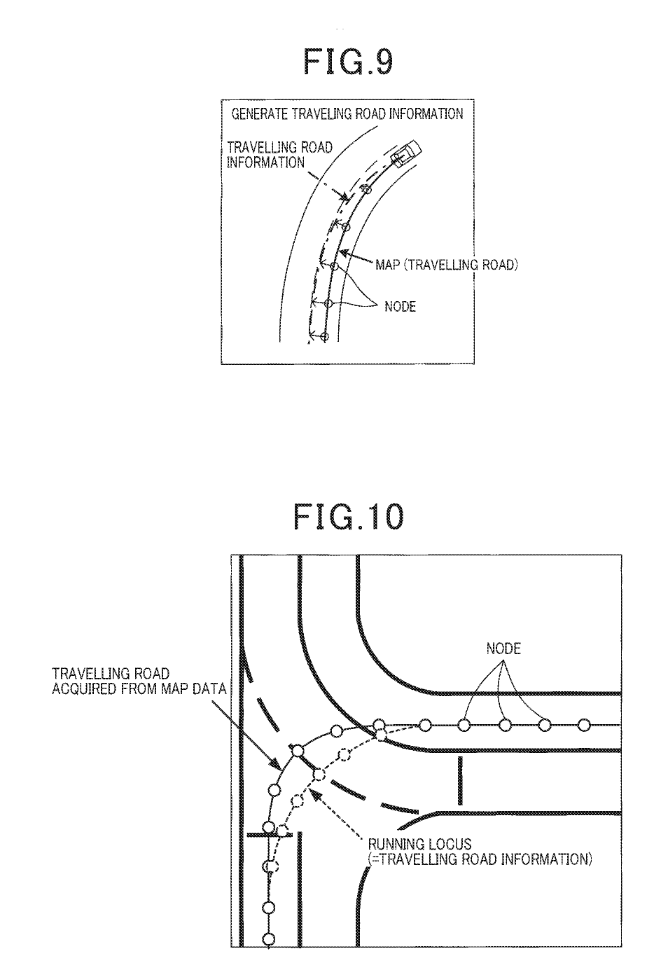

As exemplified in FIG. 9, locations of respective nodes on the travelling road acquired from the map data included in the on-vehicle apparatus are corrected with correction amounts corresponding to respective nodes, whereby the locations of the nodes on the corrected travelling road are set and these nodes are connected to each other. Hence, the traveling road information is generated.

When the travelling road information is generated at S250, the process proceeds to S260. At S260, the process transmits the travelling road information to the on-vehicle apparatus as a requestor (e.g., navigation apparatus, travelling control apparatus) via the vehicle LAN, and terminates the travelling road information generation process.

As described, the travelling road information generation system 1 according to the present embodiment is configured of the server 2 and a plurality of on-vehicle apparatuses 4 mounted on respective vehicles, in which the control unit 30 in the server 2 side acquires locus data corresponding to the actual travelling road from the plurality of on-vehicle apparatuses 4.

The control unit 30 calculates the correction amount data based on the difference between the running locus acquired from the locus data and the travelling road on the map acquired from the map data stored in the map DB 24, and stores the calculated correction amount data into the correction amount DB 28.

Also, when receiving a request signal of the correction amount from the on-vehicle apparatus, the control unit 30 reads the correction amount data in accordance with the request of the on-vehicle apparatus 4, and transmits the correction amount data to the on-vehicle apparatus 4 which sent the request signal.

On the on-vehicle apparatus 4 side, the control unit 50 uses the correction amount data transmitted from the server 2 to correct the travelling road acquired from the map data, thereby generating the travelling road information used for a travelling guide or an automatic driving of the vehicle.

Therefore, according to the travelling road information generation system 1 of the present embodiment, the travelling road acquired from the map data can be corrected in the on-vehicle apparatus 4 using the correction amount data. As a result of the correction, the travelling road information used for the actual traveling of the vehicle can be generated.

Hence, according to the present embodiment, due to variations of the running environment of the vehicle, even when the travelling road acquired from the map data is deviated from the optimized travelling road suitable for the vehicle to run, the travelling road can be corrected depending on the amount of deviation so that optimized travelling road information can be provided to other on-vehicle apparatuses.

For example, as shown in FIG. 10, in the case where the vehicle entering the intersection is making a right turn on a T-junction road, the travelling road (indicated by solid line) acquired from the map data has an excessively high curvature in the right turn direction so that the vehicle may run with less safety due to characteristics of the vehicle movement.

In this respect, according to the travelling road information generation system 1 of the present embodiment, the process collects the locus data representing the running locus of the right-turn vehicle at the intersection, and corrects the travelling road based on the locus data, whereby the vehicle can travel along the actual running locus.

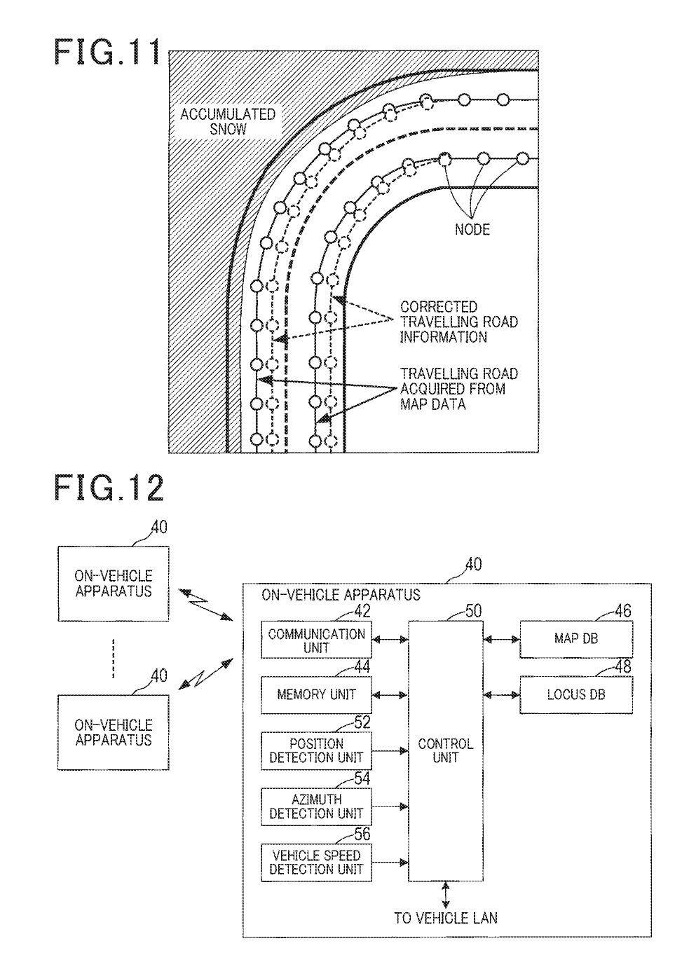

Further, for example, as shown in FIG. 11, in winter, in the case where the vehicle runs on a snowy road and snow has accumulated on the road shoulder, in order to avoid the snow, the vehicle is likely to run along the road deviated from the travelling road of the map data , away from the accumulated snow. Hence, in this case, the automatic driving vehicle is required to run similarly.

In this case, according to the travelling road information generation system of the present embodiment, by using the locus data collected under the same running environment as this running state, the travelling road acquired from the map data can be corrected. Accordingly, with the travelling road information generation system of the present embodiment, even under the conditions shown in FIGS. 10 and 11, the travelling road information which is conclusively acquired indicates a travelling road corresponding to the running locus when the vehicle is actually running under the same running environment.

Therefore, according to the present embodiment, appropriate travelling road information (i.e., scheduled travelling route) depending on the actual running environment can be provided to on-vehicle apparatuses such as travelling control apparatus performing an automatic driving of the vehicle.

In the travelling road information generation system 1 of the present embodiment, the running locus acquired from the locus data is used and original map data is not corrected. Hence, since the map data has not been changed, the map data being in the initial state can be held as a reference data of the travelling road.

Therefore, according to the present embodiment, the map data as the reference can be prevented from being erroneously updated. Hence, the map data can always be utilized. Also, the present embodiment can avoid a problem in which the processing load of the computer requires too much time to update map data so that the travelling road information cannot be generated on the latest map data corresponding to the running environment of the vehicle. Accordingly, the reliability of the travelling road information generated in the on-vehicle apparatus 4 can be enhanced.

Also, the control unit 30 of the server 30 categorizes the locus data depending on the running environment of the vehicle every time when the locus data is collected from the on-vehicle apparatus 4 and stores the categorized data into the locus DB 26. Then, every time when new locus data is stored into the locus DB 26, the process reads, from the locus DB 26, locus data having the same running environment as that of the stored locus data, and successively generates correction data by using a plurality of locus data which have been read from the locus DB 26 to update the correction amount DB 28.

on amount DB 28 are updated for every running environment. In the on-vehicle apparatus 4 side, travelling road information is generated by using the latest correction amount data, whereby the travelling road information can be generated more reliably.

When storing the locus data for generating the correction amount data into the locus DB 26, the control unit 30 of the server 2 determines whether locus data acquired from the on-vehicle apparatus 4 shows abnormal since the distance between the locus data and the travelling road on the map is far, or determines whether the locus data acquired from the on-vehicle apparatus has statistically high reliability. When the process determines that the locus data acquired from the on-vehicle apparatus 4 is normal and has high reliability, the locus data is stored into the locus DB 26. Hence, abnormal locus data having low reliability can be prevented from being stored into the locus DB 26.

According to the present embodiment, the server 2 functions as a locus data acquiring unit, a running environment acquiring unit and a correction amount calculation unit of the present disclosure, and the on-vehicle apparatus 4 functions as a map data acquiring unit, a correction amount acquiring unit, and a travelling road information generation unit of the present disclosure.

Specifically, the function of the locus data acquiring unit is accomplished by a process at S110 executed by the control unit 30, and the function of the running environment acquiring unit is accomplished by a process of S120, the function of the correction amount calculation unit is accomplished by processes of S130 to S190.

The function of the map data acquiring unit is accomplished by a process of S220 executed by the control unit 50, the function of the correction amount acquiring unit is accomplished by processes of S230 and S240, and the function of the travelling road information generation unit is accomplished by the process of S250.

As described, an embodiment of the present disclosure is described. The present disclosure is not limited to the above-described embodiments and can be modified in various ways without departing the scope of the present disclosure. For example, according to the above-described embodiments, functions of the locus data acquiring unit, the running environment acquiring unit and the correction amount calculation unit are provided in the server 2. However, these functions may be provided by the on-vehicle apparatus 40, and a single on-vehicle apparatus 40 may accomplish the travelling road information generation system.

In this case, as shown in FIG. 12, the on-vehicle apparatus 40 may include a map DB46 and a locus DB 48. Further, the communication unit 42 may directly communicate with other on-vehicle apparatuses 40 mounted on a vehicle around the own vehicle, or may communicate with other on-vehicle apparatuses 40 with radio communication via a communication network such as a mobile communication network or the internet.

As a result, the control unit 50 successively executes the correction amount DB updating process and the travelling road information generation process with a similar procedure to the above-described embodiment, whereby a generation of the correction amount data, a correction of the travelling road based on the correction amount data, and output of the travelling road information after the correction can be performed.

In this case, the correction amount data is calculated by using the latest locus data accumulated in the locus DB 48 when the travelling road information is required, and the calculated correction data is temporarily stored into the memory unit 44. Therefore, the correction amount DB is not necessarily provided in order to store the correction amount data for every running environment.

In other words, when the correction amount data is calculated by processes at S110 to S180 similar to the above-described embodiment, the calculation result may be stored into the memory unit 44. Also, the on-vehicle apparatus 40 shown in FIG. 12 includes the map DN 46 in which the map data is stored. However, the map DB 46 is not necessarily provided, but the map data may be acquired from other on-vehicle apparatus such as a navigation apparatus.

The above-described on-vehicle apparatus 4 according to the present embodiment has been described as an apparatus that acquires the map data from other on-vehicle apparatus. However, the on-vehicle apparatus 4 may include the map DB 46 similar to the configuration shown in FIG. 12, or a desired region of the map data may be acquired from the server 2.

On the other hand, a configuration has been described in which the locus DB 26 includes a plurality of locus data stored therein, and the plurality of locus data is used when the correction amount data is generated. However, a part of the plurality of locus data may be used to generate the correction amount data.

In this case, locus data used for generating the correction data has to be selected. The locus data may be selected from data having new sampling date or data having high reliability.

Similarly, the on-vehicle apparatus 40 shown in FIG. 12 may select locus data used for generating the correction amount data from the plurality of locus data stored in the locus DB 48. Note that since the locus DB 48 in the on-vehicle apparatus 40 includes the locus data indicating the running locus of the own vehicle and the locus data acquired from other vehicle are stored therein, the locus data of the own vehicle may be selected with priority when a plurality of locus data generated in the same time period are present.

According to the above-described embodiment, in accordance with a request from the on-vehicle apparatus 4, the server 2 reads the correction amount data corresponding to the position of the vehicle on which the on-vehicle apparatus 4 is running and the running environment from the correction amount DB 28, and transmits the correction amount data read by the server.

In contrast, the server 2 may transmit the updated correction amount data to all of the on-vehicle apparatuses 4 every time the correction amount DB 28 is updated. Thus, the on-vehicle apparatus 4 can hold all of the latest correction amount data relative to the map data. Hence, since it is not necessary to acquire the correction amount data from the server 2 every time the travelling road information is generated, a period for generating the travelling road information (i.e., correction of the travelling road) can be shortened.

Further, according to the above-described embodiment, the correction amount is generated in the server 2 side. However, the locus data acquired from the plurality of on-vehicle apparatus 4 may be stored in the locus DB 48 in the server 2 side, and the on-vehicle apparatus 4 may acquire the locus data from the server 2 to calculate the correction amount.

### REFRENCE SIGNS LIST

1: travelling road information generation system
2: server
4: on-vehicle apparatus
22: communication unit
24: map DB
26: locus DB
28: correction amount DB
30: control unit
40: on-vehicle apparatus
42: communication unit
44: memory unit
46: map DB
48: locus DB
50: control unit
52: position detection unit
54: azimuth detection unit
56: vehicle speed detection unit

1. A travelling road information generation system of a vehicle, the system comprising:
a map data acquiring unit that acquires map data including a travelling road on which the vehicle is capable of travelling;
a locus data acquiring unit that acquires locus data indicating a running locus when the vehicle actually travels on the travelling road;
a correction amount calculation unit that calculates, based on the locus data, a correction amount necessary for generating travelling road information from the map data, the travelling road information being suitable for travelling of the vehicle; and
a travelling road information generation unit that corrects the travelling road acquired from the map data using the correction amount to generate the travelling road information wherein
the locus data acquiring unit is configured to acquire the locus data from a plurality of vehicles.

2. (canceled)

3. The travelling road information generation system according to claim 1, wherein
the apparatus includes a running environment acquiring unit that acquires a running environment corresponding to the locus data acquired by the locus data acquiring unit;
the correction amount calculation unit is configured to hold the correction amount calculated based on the locus data, being associated with the running environment; and
the travelling road information generation unit is configured to generate the travelling road information using a correction amount corresponding to a current running environment of the vehicle, among the correction amounts being held by the correction amount calculation unit.

4. The travelling road information generation system according to claim 1, wherein
the correction amount calculation unit is configured to calculate the correction amount based on a difference between the map data and the locus data.

5. The travelling road information generation system according to claim 4, wherein
the correction amount calculation unit is configured to successively update the difference between the map data and the locus data to calculate the correction amount.

6. The travelling road information generation system according to claim 3, wherein
the correction amount calculation unit is configured to successively update or calculate the difference between the map data and the locus data for each running environment, and set the correction amount for each running environment based on the updated or calculated difference.

7. The travelling road information generation system according to claim 1, wherein
the map data acquiring unit is configured to hold the map data as an initial state.

8. The travelling road information generation system according to claim 1, wherein
the correction amount calculation unit is configured to calculate
a correction distance towards a direction perpendicular to the travelling road at each node of the travelling road acquired from the map data, or
a positional deviation on a coordinate of the map data at each node, to be the correction amount.

9. The travelling road information generation system according to claim 1, wherein
the locus data acquiring unit is configured to hold a past running locus acquired from the vehicle to be the locus data.

10. The travelling road information generation system according to claim 1, wherein
the locus data acquiring unit is configured to acquire positional information acquired from a sensor which is mounted on the vehicle and used for detecting a vehicle position, to be the locus data.

11. The travelling road information generation system according to claim 1, wherein
the travelling road information generation system is mounted on a vehicle;
the locus data acquiring unit is configured to be capable of acquiring the locus data from an own vehicle and an other vehicle;
the correction amount calculation unit is configured to utilize the locus data acquired from the own vehicle to calculate the correction amount, when a plurality of locus data acquired from the own vehicle and the other vehicle are present as the locus data acquired by the locus data acquiring unit and capable of being used for calculating the correction amount.

12. The travelling road information generation system according to claim 1, wherein
the correction amount calculation unit is configured to utilize locus data having a new generation timing to calculate the correction amount, when a plurality of locus data acquired by the locus data acquiring unit and capable of being used for calculating the correction amount are present.

13. The travelling road information generation system according to claim 1, wherein
the correction amount calculation unit is configured to utilize locus data having high reliability, when a plurality of locus data acquired by the locus data acquiring unit and capable of being used for calculating the correction amount are present.

14. The travelling road information generation system according to claim 1, wherein
the running environment acquiring unit is configured to acquire running environment corresponding to the locus data, from a sensor disposed in a vehicle in which the locus data acquiring unit acquired the locus data or disposed in a travelling road side of the vehicle.

15. An on-vehicle apparatus comprising:
a map data acquiring unit that acquires map data including a travelling road on which the vehicle is capable of travelling;
a correction amount acquiring unit that acquires a correction amount necessary for generating travelling road information from the map data, the travelling road information being suitable for travelling of the vehicle;
a travelling road information generation unit that corrects the travelling road acquired from the map data using the correction amount acquired from the correction amount acquiring unit to generate the travelling road information.
